(19) United States
(12) Patent Application Publication
(10) Pub. No.: US 2025/0034480 A1
(43) Pub. Date: Jan. 30, 2025

(54) FAT RENDERING

(71) Applicant: NESTE OYJ, Espoo (FI)

(72) Inventors: Ville PATOLA, Porvoo (FI); Floris EBELI, Porvoo (FI); Jukka-Pekka PASANEN, Porvoo (FI); Blanka TOUKONIITTY, Porvoo (FI)

(21) Appl. No.: 18/712,972

(22) PCT Filed: Nov. 23, 2022
(86) PCT No.: PCT/EP2022/083036

§ 371 Date: May 23, 2024

(30) Foreign Application Priority Data
Nov. 24, 2021 (EP) 21210119.0
Nov. 24, 2021 (FI) 20216199

(51) Int. Cl. C11B 3/04; C11B 3/00; C11B 3/10; C11B 13/00

(52) U.S. Cl. CPC C11B 3/04; C11B 3/001; C11B 3/10; C11B 13/00

(57) ABSTRACT

A method is disclosed for purifying animal waste feedstock. The method comprises providing animal waste feedstock (100) containing fat solids, and heating said animal waste feedstock (100) to an elevated temperature of 100° C. or below to liquefy (102) the fat solids in the animal waste feedstock (100), thereby obtaining liquefied fat. The liquefied fat is isolated from solid material to obtain isolated liquefied fat. The isolated liquefied fat is subjected to bleaching (106) in the presence of acid (113) and sorbent to obtain bleached liquefied fat.

### FIELD OF THE INVENTION

The invention relates to fat rendering, and particularly to a method for purifying animal waste or other waste feedstock.

### BACKGROUND ART

Animal waste or other waste feedstock containing fat solids typically contains phosphorous, nitrogen and/or metal containing impurities. Before catalytic processing of the waste feedstock to traffic fuels these impurities need to be removed to prevent catalyst deactivation and/or plugging during processing. Also high concentration of toxic ammonia may be generated from the nitrogen compounds if the waste feedstock is processed by hydrogenation. Furthermore, in traffic fuels, nitrogen compounds cause NOx emissions.

A waste feedstock purification method may involve the steps of fat rendering, heat-treatment and bleaching. In heat-treatment, impurities are precipitated at an elevated temperature. In bleaching, removal of impurities is achieved using adsorption on clay. Fat rendering may be a low temperature wet rendering process, or a high temperature dry rendering process.

### SUMMARY

The following presents a simplified summary of features disclosed herein to provide a basic understanding of some exemplary aspects of the invention. This summary is not an extensive overview of the invention. It is not intended to identify key/critical elements of the invention or to delineate the scope of the invention. Its sole purpose is to present some concepts disclosed herein in a simplified form as a prelude to a more detailed description.

According to an aspect, there is provided the subject matter of the independent claim. Embodiments are defined in the dependent claims.

One or more examples of implementations are set forth in more detail in the description below. Other features will be apparent from the description, and from the claims.

### BRIEF DESCRIPTION OF THE DRAWINGS

In the following the invention will be described in greater detail by means of preferred embodiments with reference to the attached drawing, in which

FIG. 1 is a flow chart illustrating an exemplary purifying method.

### DETAILED DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising”, “containing” and “including” should be understood as not limiting the described embodiments to consist of only those features that have been mentioned and such embodiments may also contain features/structures that have not been specifically mentioned.

A method is disclosed herein for purifying feedstock of renewable biological origin. The biological feedstock to be purified by the present method comprises acylglycerols, free fatty acid and nitrogen containing compounds. The term “acylglycerols” includes triglycerides, diglycerides, and monoglycerides, which have a glycerol backbone and respectively three, two or one fatty acid(s) bound via an ester bond to the glycerol backbone. The fatty acid(s) of the acylglycerols typically have a carbon chain length from 8 to 32 carbon atoms. The fatty acids may be saturated or unsaturated fatty acids having from 0 to 4 double bonds. The term “free fatty acids” includes saturated and unsaturated fatty acids which are in the form of a free carboxylic acid, i.e. not bound to a glycerol backbone. The free fatty acid content of the biological feedstock depends on the origin of the biological material. Typically, the free fatty acid content of the biological feedstock is at least 2 wt-%, particularly at least 5 wt-%, more particularly from 6 to 25 wt-%, such as from 8 to 20 wt-%, of the total weight of the biological feedstock.

Specifically, a method is disclosed herein for purifying animal waste feedstock containing fat solids. Generally speaking, fats that are solid at room temperature are referred to as fat solids. In the method of the present invention, animal waste feedstock containing fat solids and nitrogen-containing compounds is provided. Said animal waste feedstock is heated to an elevated temperature of 100° C. or below to liquefy the fat solids in the animal waste feedstock, thereby obtaining liquefied fat and solid material. The liquefied fat is isolated from the solid material to obtain isolated liquefied fat. The liquefying of the fat may also be referred to as fat rendering. When the isolated liquefied fat is subjected to bleaching with acid and sorbent the bleached liquefied fat is obtained.

In an embodiment of the invention, the animal waste may be fresh meaning without maturation, such that the feedstock is being processed soon after the animal has been perished or slaughtered. Alternatively, the animal waste may have been matured for days. In general, the feedstock is preferred not to be matured to a great extent in order to reduce the amount of degradation to the waste material. Degradation of the waste material may result in higher amounts of low molecular weight nitrogen compounds made available for side reactions when heat is being applied to the waste material during the rendering and purifying process. In the present invention, the heating of said animal waste feedstock to the elevated temperature of 100° C. or below to liquefy the fat solids in the animal waste feedstock, enables obtaining nitrogen-depleted liquefied fat and solid material. The nitrogen-depleted liquefied fat is isolated from the nitrogen-enriched solid material to obtain the isolated liquefied fat. The liquifying and isolating may be carried out in a container, preferably a container configured to separate the liquefied fat from the solid material as soon as it forms, such as a screw press. The isolating is carried out immediately after the liquifying, thereby minimising and/or avoiding undesired nitrogen derivative compound formation, such as amide, amine and/or other nitrogen by-product formation. The solid material thus becomes nitrogen-enriched solid material.

Before bleaching, the isolated liquefied fat may be subjected to heat-treatment to precipitate phosphorous and/or metal containing impurities. Before bleaching and before optional heat-treatment, the isolated liquefied fat may be subjected to sterilization. The sterilization may be pressure sterilization, wherein the isolated liquefied fat is subjected to heating at above 130° C. for a duration of at least 10 minutes. Before bleaching, and before the optional heat-treatment/sterilization, the isolated liquefied fat may be subjected to removal of stick water e.g. by centrifugation. Stick water refers to the remaining liquid from the rendering process that is an aqueous solution containing protein materials and other bionutrients. The bleached and optionally heat-treated liquefied fat may then be used as feedstock for biofuel production as such or having undergone additional purification steps.

Herein, animal waste feedstock containing fat solids refers to as waste material of renewable animal origin. It also refers to any waste stream received from processing of such waste material. The term “renewable” refers to the recycling of the waste material of animal origin, and to the non-fossil origin of the waste material. And “non-fossil” refers to any other fossil feedstock, such as crude oil/petroleum/natural gas etc so that it includes bio based or animal/plant based materials. The waste material of animal origin may be obtained from slaughter houses, for example. The waste feedstock may be in an unprocessed form (e.g. animal waste or animal fat). Used cooking oil is not obtained directly from a rendering process.

Examples of animal waste feedstock in the present invention include, but are not limited to solid animal fat containing material such as suet, tallow, blubber, recycled alimentary fats and/or low quality animal fat (AF) with very high N, PE, metals and/or phosphorus content, animal carcasses obtained as slaughterhouse wastes, or any other meat materials containing fat solids, are suitable for the rendering process as claimed herein.

The waste feedstock to be used in the present invention is a waste feedstock to be upgraded into a material that may serve as a source for biofuel production of any kind. The purified material has to be of such a quality that it reduces the demand on the further processing steps such as e.g. catalytic cracking, by containing low levels of impurities that may e.g. jeopardize the lifetime of the catalysts by poisoning the catalysts, or otherwise hampering of any further downstream processes that the purified material may be subjected to. Such further processing may include e.g. catalytic cracking, thermo-catalytic cracking, catalytic hydrotreatment, fluid catalytic cracking, catalytic ketonization, catalytic esterification, or catalytic dehydration.

The liquefied fat obtained from fat rendering, which may also be referred to as rendered fat, typically contains impurities comprising nitrogen, phosphorus and/or metals in the form of phospholipids, soaps and/or salts. The impurities may, for example, be in the form of phosphates or sulfates, iron salts or organic salts, soaps or phospholipids. The metal impurities that may be present in the feedstock are, for example, alkali metals or alkali earth metals, such as sodium or potassium salts, or magnesium or calcium salts, or any compounds of said metals. The phosphorous compounds present in the feedstock are typically phospholipids. The phospholipids present in the feedstock may be one or more of phosphatidyl ethanolamines, phosphadityl cholines, phosphatidyl inositols, phosphatidic acids, and phosphatidyl ethanolamines.

In one embodiment of the present invention, the fat rendering step may include feeding the animal waste feedstock into the container without using water and/or steam as a heat source, whereas the heat source of the crude feedstock is provided via a container using a heat exchanger, and the temperature of the feedstock is elevated to 100° C. or any degrees below, such as 75, 80, 85, 90, 95° C., high enough to cause the fat solids in the feedstock to liquefy and be released from the solids while residing in the container, as long as the heating temperature does not go beyond 100° C. The preferred optimal temperature can be adjusted accordingly by monitoring the nitrogen content in the rendered fat. Preferably, the heating of the animal waste feedstock takes place at a slow rate, e.g. for 30-90 minutes, so as to avoid localised heating. Preferably, the heat is being supplied evenly throughout the raw material, thus minimising the time it takes to liquefy the fat solids.

In one embodiment the container is a container configured to separate the liquefied fat from the solid material as soon as it forms or during liquefaction. This is advantageous as the nitrogen impurities thus have a very short contact time with the liquefied fat and effectively remain in the solid material phase. Advantageously the container may be e.g. a screw press. In the screw press the fat material is pressed alongside of the screw the body of which is working as a heat exchanger providing simultaneously heat to the fat material thus allowing the fat material to liquefy when reaching the applicable temperature. The liquefied fat material is separated via the small holes in the screw press body from the rest of the fat material still in solid phase. Advantageously, the contact time of the liquefied fat with the nitrogen compounds residing in the solid fat material is thus minimised and the side reactions producing undesired nitrogen derivatives, such as amides, can be effectively avoided. Thus the isolating is carried out immediately after the liquifying, thereby minimising and/or avoiding undesired nitrogen derivative compound formation, such as amide, amine and/or other nitrogen by-product formation. The use of a screw press enables even heating of the container, and local heat peaks in the container can thus be avoided, which minimises undesired nitrogen derivative compound formation.

In one embodiment of the present invention, the separated fat obtained directly from the rendering step can be circulated immediately back into the rendering step. As the separated fat is still not completely cooled down it would serve as the heating medium further facilitating the heat transfer to the fat solid to be rendered.

In one embodiment of the present invention, the heat source of the heating step is from a heat exchanger in the form of heat plates having large surface areas. The large surface area is beneficial to provide even heating to the raw material, so as to prevent any excessive heating in any isolated regions. In another aspect, the heat exchanger may also be a scraped heat exchanger, so that the surfaces of the heat exchanger can be scraped so as to allow fresh contacts with the raw material.

Furthermore, an exemplary reactor may be implemented with separator means which is capable of serving as a barrier and at the same time allowing a flow of the liquefied fat to be formed from the container into a heat-treatment vessel.

In one embodiment of the invention, the separator means is introduced to the container where the crude feedstock is heated, as a guard bed having perforations. The feedstock may be placed upon said guard bed and the perforations are configured such that the liquefied fat is allowed to drain through.

In one embodiment of the invention, the residence time of the fat, and compounds derived from amino acids, or solid protein, during fat rendering is optimised such that liquefied fat is being removed simultaneously, thus the liquefied fat is being separated from the crude solid as soon as the fat solid is liquefied. The heating time is defined as the time duration needed to reach the desired temperature. The residence time may be understood as the time duration in which any material such as the liquefied fat, remains in the reactor under elevated temperature. Preferably the heating time to obtain the nitrogen-depleted liquified fat is minimized. Because of the short or minimized residence time, it is possible to prevent undesired nitrogen compounds from entering the liquified fat to be isolated.

In one embodiment of the present invention, the removal of the liquefied fat may be carried out simultaneously during the heating step, and this provides an advantage that in case the heating of the feedstock takes place at temperatures higher than expected, any unwanted side reactions can be minimised. The residence time of the liquefied fat and proteins or amino acids is, in general, preferred to be minimised in order to reduce the likelihood of any unwanted chemical reactions occurring between them during fat rendering. Unwanted side chemical reactions may be, for example, amides and/or amines and/or other nitrogen by-product/nitrogen derivative compound formation. Amides, amines and other nitrogen derivative compounds are seen as unwanted impurities that impair the quality of the material, in particular, if the material is to be served as feedstock for downstream processing, for example, production of biofuels. Respectively, the heating time of the animal waste feedstock is, in general, preferred to be minimised in order to reduce the likelihood of said unwanted chemical reactions occurring during fat rendering.

It has been observed that any presence of amides even in minute quantities in the feedstock poses an economic problem that needs to be addressed in the context of biofuel production. The cost includes any purification treatments prior to catalytic hydrotreatment on amides in the material. The nitrogen compounds are a source for production of ammonia during catalytic hydrotreatment. In order to avoid ammonia ending up in wastewater treatment costs are imposed on ammonia removal before wastewater can be safely disposed of. Furthermore the nitrogen compounds are the chemicals that could passivate into the catalysts used in the catalytic hydrotreatment for biofuels production resulting in a reduction in the activity of the catalysts, subsequently requiring a replacement of new catalysts. Therefore the present invention intends to address these low quality feedstock issues reducing the amount of processing required to upgrade the fat waste products into higher valued products. The present invention enables isolating nitrogen-depleted liquefied fat from solid material. The obtained isolated liquefied fat is “nitrogen-depleted” liquefied fat, i.e. it contains a very low or reduced amount of undesired nitrogen-derived compounds (nitrogen derivative compounds), such as amides, amines and/or other nitrogen by-products compared to the amount of nitrogen compounds in the feedstock or in a fat liquefied at a higher temperature. The obtained solid material is “nitrogen-enriched”, i.e. it contains a higher amount of undesired nitrogen-derivative compounds, such as amides, amines and/or other nitrogen by-products compared to the amount of nitrogen compounds in the feedstock.

The time during which the animal waste feedstock is held at the desired temperature of 100° C. or below, such as 75-100° C., may vary depending on the size of the reactor and/or the amount of raw material, as well as the surface area of the raw material to be rendered; the time may be adjusted accordingly so as to maximise the amount of fat solid to be liquefied. The heating time can be set to be around 30-90 minutes in order to reach the desired temperature, preferably around 60 minutes. This can vary depending on the volume of the feedstock to be heated but it is set accordingly to ensure that heating takes place gradually and uniformly. As for the residence time duration in which the material is held at 100° C. is 2-10 minutes, and the same applies to lower temperatures. In order to optimise the heat transfer the method may further include reducing the particle size of the animal waste feedstock such as cutting the animal waste into cubes or by grinding or mincing, before feeding the reduced feedstock into the container for the fat rendering. The heating time of the animal waste feedstock is, in general, preferred to be minimised in order to reduce the likelihood of said unwanted chemical reactions occurring during fat rendering. However, the heating time is to be long enough to allow the animal waste feedstock to be heated evenly or sufficiently evenly. Even heating may also improve the productivity of fat rendering.

In one embodiment of the present invention, the isolated liquefied fat is subjected to removal of solid impurities and/or stick water before the heat-treatment step, the sterilization, or the bleaching step. In one embodiment of the present invention, the isolated liquefied fat is subjected to removal of solid impurities after the sterilization and heat treatment. The removal of solid impurities and/or stick water may be performed by means of centrifugation, filtration, or acid treatment, for example. After the solid removal step, it is optional to circulate one part of the isolated liquefied fat back to the reactor where the raw fat solids are being rendered. Before being fed back into re-circulation, the temperature of isolated liquefied fat can be first adjusted accordingly, i.e. between 50-100° C., preferably 70-80° C.

The heat-treatment step of the isolated liquefied fat may be carried out at a temperature from 180 to 300° C., preferably 240° C. to 280° C. The heat-treatment of the isolated liquefied fat may be carried out at a pressure from 50 kPa to 500 kPa, possibly from 70 to 400 kPa, particularly from 100 to 300 kPa, preferably from 105 to 270 kPa. The time during which the biological feedstock is heated and held at the desired temperature, i.e. the residence time, is typically from 1 to 300 mins, preferably from 5 to 240 mins, more preferably from 30 to 90 mins, depending on the dimensions of the apparatus.

The bleaching step may be carried out with a sorbent such as bleaching clay to adsorb/absorb impurities. Sorbents are insoluble materials or mixtures of materials used to recover atoms, molecules or ions through the mechanism of absorption, adsorption, ion exchange, or any combination of these. In the bleaching step, the heat-treated and sterilized liquefied fat may be heated to a certain temperature, after which citric acid and/or phosphoric acid may be added. If both citric acid and phosphoric acid are used, the phosphoric acid is added immediately after the citric acid. After slow mixing, water may be added. Stirring may then be carried out. A nitrogen flow may be applied during the mixing (i.e. stirring). Citric acid and water may also be added at the same time. Citric acid may be added first, followed by water. The bleaching may involve one or more fast mixing steps and one or more slow mixing steps. The material to be bleached is stirred and allowed to warm, followed by adding the sorbent and applying a vacuum or reduced pressure. The bleaching clay is subsequently separated from the material, after bleaching has been carried out, by means of filtration for example.

In any one embodiment of the present invention, the method herein may be devised to be a continuous process or a batch process, preferably a continuous process. The fat rendering, centrifugation, sterilization, heat-treatment, and/or bleaching steps may be carried out in the same reaction vessel, or they may be performed separately in different reaction vessels.

In one embodiment of the invention, the isolated fat liquefied may be further blended with another fat component before the heat-treatment step, the sterilisation step or the bleaching step, or any combinations of these steps. The blending with another fat component typically utilises the blendability of the liquefied fat with another fat components further taking advantage of other fat components having an impurities profile different from that of the animal based fat, such as having a low level of nitrogen content, to further reduce the concentration of nitrogen content of the low temperature liquefied fat. The blending can also be seen, vice versa, to take advantage of the already low nitrogen content of the low temperature rendered fat so that it can be blended with other low quality fats, as an example for illustration, high temperature beyond 100° C. rendered fats. The oils and/or fats may be used for blending with the low temperature rendered fat can be a wide range of waste material of renewable (i.e. non-fossil) plant and/or microbial origin, such as sludge palm oil (SPO) or sludge palm oil (SPO) with very high iron content, and/or used cooking oil (UCO) such as used cooking oil (UCO) used in deep frying and containing high level of oligomers and chlorides.

One example of other fat components to be used for blending with the present claimed low temperature rendered fats includes animal based fat obtained from other types of rendering methods such as dry/wet rendering above 100° C. In another embodiment of the other fat components, plant-based fat waste is used for blending, since plant-based fat waste typically does not contain proteins, so that plant-based fat waste is inherently low in nitrogen content. The plant-based fat waste may be, for example, vegetable or plant based oils and other types of fats including sludge palm oil, used cooking oil, microbial oils, algae oils, free fatty acid, triglycerides, any qualities of lipids containing phosphorus and/or metals, oils originating from yeast or mold products, oils originating from biomass, rapeseed oil, canola oil, colza oil, tall oil, sunflower oil, soybean oil, hemp oil, olive oil, linseed oil, cottonseed oil, mustard oil, palm oil, arachis oil, castor oil, coconut oil, and/or any mixtures of said feedstocks.

The present invention provides an optimised pre-treatment processing method of the waste feedstock containing fat and fatty acids. The present invention enables the reduction of the total nitrogen content and simultaneously the reduction of amide, amine and other nitrogen-derived by-product formation during the rendering process, and thereby reducing the costs arising from further pretreatment steps to remove nitrogen and/or handling of side products such as ammonia formed from nitrogen impurities, and phosphorus in the material. In the present invention the fat rendering enables obtaining nitrogen-depleted liquefied fat. Thus the pre-treatment processing steps provide a nitrogen-depleted liquefied fat product that is optimised for downstream processing in particular for producing biofuel which involves the use of nitrogen sensitive catalysts. The present invention also has the advantage of not requiring a large amount of water consumption, so that waste water recycling problems can be minimised.

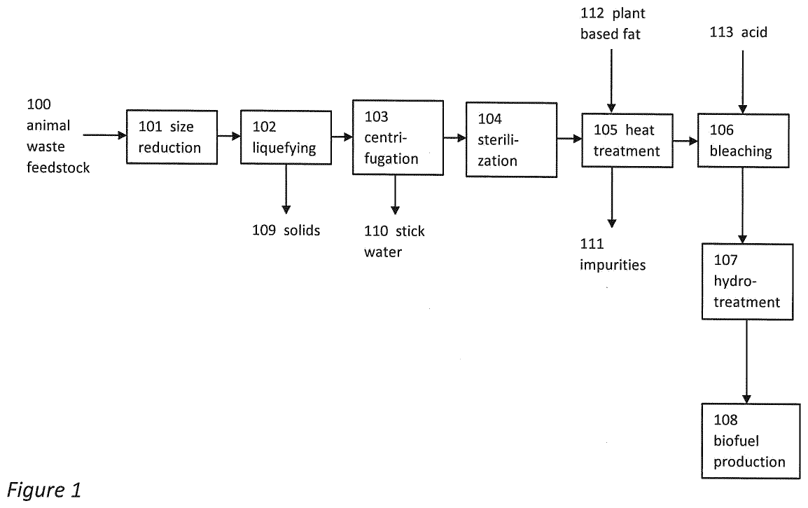

FIG. 1 illustrates an exemplary pre-treatment method for animal waste feedstock purification. Referring to FIG. 1, the method comprises the steps of fat rendering 102, and bleaching 106, after which purified fat may be fed to biofuel production 108. In the purification method, animal waste feedstock 100 is provided. The waste feedstock 100 is animal waste feedstock containing fat solids and nitrogen containing compounds. Preferably, the waste feedstock 100 is of renewable biological origin. The waste feedstock 100 is fed to fat rendering 102 where the animal waste feedstock is heated, in a container, such as a screw press, to an elevated temperature of 100° C. or below to liquefy the fat solids in the animal waste feedstock.

Before the fat rendering 102, the feedstock 100 may be subjected to size reduction 101 to reduce the particle size of the feedstock 100. The heating of the animal waste feedstock to the elevated temperature of 100° C. or below, is carried out in the fat rendering step 102 in the container by means of a heat exchanger. The duration of the heating of the animal waste feedstock to the elevated temperature of 100° C. or below to liquefy the fat solids in the animal waste feedstock is minimized. The heating of said animal waste feedstock to an elevated temperature of 100° C. or below to liquefy the fat solids in the animal waste feedstock, enables obtaining nitrogen-depleted liquefied fat and solid material 109. The nitrogen-depleted liquefied fat is isolated from the solid material 109 to obtain isolated liquefied fat. The isolating is carried out simultaneously or immediately after the liquifying, thereby minimising undesired nitrogen derivative compounds formation. The isolating of the liquefied fat from the solid material 109, may be carried out by means of separator means in the container. The separator means may be a guard bed having perforations, upon which the feedstock is placed in the container.

In step 103, the isolated liquefied fat from which solids 109 have been removed, may be subjected to a vacuum treatment and/or centrifugation 103 for removal of any volatiles, stick water 110, air, and/or easily vaporizable light hydrocarbons and fine solids. The isolated liquefied fat from which water 110 and fine solids may have been removed by the centrifugation 103, may be fed to heat-treatment 105 where the isolated liquefied fat is subjected to heat-treatment 105 to precipitate phosphorous and/or metal containing impurities 111 from the material, thereby obtaining heat-treated liquefied fat. The heat-treatment 105 may be carried out at any temperature from 180° C. to 300° C., preferably from 240° C. to 280° C. The time during which the biological feedstock is heated and held at the desired temperature, i.e. residence time, is typically from 1 to 300 min, preferably from 5 to 240 min, more preferably from 30 to 90 min, depending on the dimensions of the apparatus. During the heat-treatment step 105 excess pressure may be applied on the biological feedstock. The pressure in the heat-treatment step 105 may be from 50 kPa to 500 kPa, possibly from 70 to 400 kPa, particularly from 100 to 300 kPa, preferably from 105 to 270 kPa.

In the bleaching step 106, the precipitated phosphorous and/or metal containing impurities may be removed from the liquefied fat (e.g. by filtering). This means that solid residue is either formed in the heat-treatment process 105 from degraded phosphorous and/or metal containing impurities or originally present in the biological feedstock which can be separated from the feedstock by a filtering process. In the filtering process, various components may be used to enhance the filtering, such as sorbents and/or bleaching clay. The bleaching step 106 can also be referred to as a filtering step. Further in step 105, the liquefied fat may be blended with plant-based fat 112, wherein the obtained fat blend is subjected to the heat-treatment 105.

In one embodiment of the present invention, the heat-treated liquefied fat may be fed to a sterilization step 104 and thereafter to the bleaching step 106 where the liquefied fat is subjected to bleaching 106 with acid 113 and sorbent to obtain purified liquefied fat. In one embodiment of the present invention, the liquefied fat may be fed to the sterilization step 104 after (or before) the centrifugation 103 and before the heat-treatment 105. The acid 113 in the bleaching step 106 may be citric acid and/or phosphoric acid. The sorbent may be bleaching clay. In the sterilisation step 104, the liquefied fat is subjected to sterilisation under the condition of heating the liquefied fat at above 130° C. for a duration of at least 10 minutes to sterilise any harmful viruses and bacteria in the liquefied fat. The conditions required for sterilisation need to comply with the standards set out by the regulations of the country where the rendering facility is located. After sterilisation 104, the liquefied fat can be safely stored and/or transported to downstream processing plants to carry out heat-treatment 105, bleaching 106 and optional hydrotreatment 107. Therefore in a preferred embodiment, sterilisation step 104 is carried out directly after the rendering step 102 and optional centrifugation 103.

The purified fat obtained from the bleaching 106 may be fed to the biofuel production 108. For biofuel production 108, the purified fat may be subjected to catalytic hydrotreatment 107. The hydrotreatment process 107 typically takes place under continuous hydrogen flow. The hydrotreatment 107 may be performed at a temperature from 250 to 380° C., preferably from 275 to 360° C., more preferably from 280 to 350° C. Typically the pressure in the hydrotreatment step 107 is from 4 to 20 MPa. A hydrotreating catalyst used in the hydrotreatment process 107 may comprise at least one component selected from suitable elements of the IU-PAC group 6, 8 or 10 of the Periodic Table. Preferably, the hydrotreating catalyst is a supported Pd, Pt, Ni, NiW, NiMo, or a CoMo catalyst, and the support is zeolite, zeolite-alumina, alumina and/or silica. Most preferably NiW/Al₂O₃, Ni—Mo/Al₂O₃, or CoMo/Al₂O₃ is used. In particular, the hydrotreating catalyst is a sulfided NiW, NiMo or CoMo catalyst.

FIG. 1 should not be understood as limiting the described embodiments to consist of only those features that have been mentioned and such embodiments may contain also features/structures that have not been specifically mentioned. Features/structures mentioned in FIG. 1 may also be omitted from an embodiment, and/or they may be carried out in order different from the given one.

### Example A

The raw material for the experiment was ground pork carcass that had been frozen directly after the material was produced. This material was kept frozen until the rendering experiments were conducted.

For the low temperature rendering the animal by-product was melted at room temperature over one night and the low temperature rendering process was conducted by heating the biomass homogeneously for 60 minutes in an oil bath until the temperature of the biomass reached 94° C. Biomass was mixed during the duration of the heating. After the temperature of 94° C. was reached the solid biomass, water, and fat were separated by centrifugation (4400 rpm, 10 minutes at 90° C.).

A sample of the separated fat (named low temperature rendered fat prior sterilization) was taken and the rest of the fat was sterilized by heating the separated fat to 135° C. in a pressure reactor and kept at this temperature for 21 minutes under the pressure created by the small amount of moisture left in the fat. After this the temperature of the fat was gradually reduced and a sample was taken from the cooled down fat (named low temperature rendered fat after sterilization). The sterilization was conducted in order to study the effect of sterilization on the low temperature rendered fat.

In order to compare the nitrogen content of the low temperature rendered fat and dry rendered fat, dry rendering using the same raw material was conducted. Firstly, the ground pig carcass was partly dried by heating the biomass to 98° C. for 60 minutes in a vacuum. The partly dried biomass was then heated to 140° C. in a pressure reactor and kept at this temperature for 24.5 minutes under the pressure created by the moisture left in the biomass. After this the temperature of the material was lowered gradually to 100° C. and the biomass was kept at this temperature for 30 minutes. After this the temperature of the material was gradually reduced. After this the solid biomass, water, and fat were separated by centrifugation (4400 rpm, 10 minutes at 90° C.) and a sample was taken of the fat (named dry rendered animal fat).

These three samples were analysed for total nitrogen using method ASTMD4629. Additionally, more detailed nitrogen compound analysis was conducted. Putrefaction chemicals that are light molecular weight nitrogen compounds were analysed using gel permeation chromatography. Fatty acid amides were analysed using gas chromatography and mass spectrometry.

As can be seen from table 1 the total nitrogen content of the low temperature rendered fat is considerably lower than that of dry rendered fat, when the raw material was the freshly rendered pork carcass that was frozen directly after the material was milled.

It is also shown that the sterilization of the low temperature rendered fat does not alter the total nitrogen content, but it alters considerably the identified nitrogen compounds of the fat. Prior to sterilization only 6% of the nitrogen compounds of the fat could be identified, but after the sterilization practically all nitrogen was in the form of fatty acid amides. Similarly, in dry rendered fat all of the total nitrogen was in the form of fatty acid amides. Any nitrogen containing compounds formed from rendering can reduce the quality of the feedstock by raising its nitrogen content of the feedstock; this leads to an adverse effect on the functioning as well as quality of the subsequent processing steps, i.e. bleaching, heat-treatment, and hydrotreatment.

TABLE 1

| | | | Low | Low |
|---|---|---|---|---|
| | | | temperature | temperature |
| | | | rendered | rendered |
| | | Dry | fat after | fat prior |
| | Unit | rendered | sterilization | sterilization |
| Nitrogen | mg/kg | 71 | 29 | 31 |
| 2-piperidone | mg/kg | 0 | 0.36 | 0 |
| 2-piperidone | N mg/kg | 0 | 0.1 | 0 |
| 2-pyrrolidone | mg/kg | 10 | 0.21 | 0 |
| 2-pyrrolidone | N mg/kg | 1.6 | <0.1 | 0 |
| indoles | mg/kg | 7.17 | 4.67 | 5.0 |
| indoles | N mg/kg | 0.9 | 0.6 | 0.6 |
| p-amides | wt-% | 0.18 | 0.06 | 0 |
| p-amides | N mg/kg | 98 | 32.6 | 1.2 |

| | | | |
|---|---|---|---|
| Individual components | 100.5 | 33.2 | 1.8 |
| N mg/kg | | | |
| % of individual component | 143 | 114 | 6 |
| N of total N | | | |

The example A shows the beneficial effect of using low temperature rendering as specified in our embodiments resulting in lowered total nitrogen content.

### Example B

The raw material for the experiment was ground pork carcass that had been kept at room temperature (25° C.) for 24 hours before it was frozen. This material was kept frozen until the rendering experiments were conducted.

Both low temperature rendering and dry rendering were conducted on a sample B in a similar manner as conducted in example A. The low temperature rendered fat was not sterilized. Two samples were taken: Low temperature rendered fat prior sterilization and Dry rendered fat. Two separate rendering runs were conducted.

The samples from the first of these rendering runs were analysed for total nitrogen (ASMTD4629) and additionally elemental impurities were analysed using method ASTMD5185. The samples from the second rendering run, i.e. the repetition were only analysed for the total nitrogen content using method ASTMD4629.

Table 2 and Table 3 provide experimental data on the samples that are matured animal waste that have been subjected to dry rendering and low temperature rendering. The beneficial effect of low temperature rendering is observed to be more pronounced when the original animal raw material is matured or degraded i.e. not fresh or have been left to stand at room temperature for an extended period of time. This is the actual case with many animal by-products. It can also be seen that low temperature rendering has the possibility to reduce elemental impurities in addition to reducing the total nitrogen content of the separated fat.

TABLE 2

| | | Experiment 1 | |
|---|---|---|---|
| | | | Low |
| | | | temperature |
| | | | rendered |
| | | Dry | fat prior |
| | Unit | rendered | sterilization |
| Sum of Ca, | mg/kg | 114 | 17 |
| Mg, Na, Fe | | | |
| Nitrogen | mg/kg | 530 | 63 |

TABLE 3

| | | Experiment 2, repetition | |
|---|---|---|---|
| | | | Low |
| | | | temperature |
| | | | rendered |
| | | Dry | fat prior |
| | Unit | rendered | sterilization |
| Nitrogen | mg/kg | 400 | 170 |

It will be obvious to a person skilled in the art that, as the technology advances, the inventive concept can be implemented in various ways. The invention and its embodiments are not limited to the examples described above but may vary within the scope of the claims.

1. A method for purifying animal waste feedstock, the method comprising:
providing animal waste feedstock containing fat solids and nitrogen-containing compounds;
heating said animal waste feedstock to an elevated temperature of 100° C. or below to liquefy the fat solids in the animal waste feedstock, thereby obtaining nitrogen-depleted liquefied fat and solid material and isolating the nitrogen-depleted liquefied fat from the solid material to obtain isolated liquefied fat, wherein the duration of the heating of the animal waste feedstock to the elevated temperature of 100° C. or below to liquefy the fat solids in the animal waste feedstock is minimized, and wherein the isolating is carried out immediately after the liquifying, thereby minimising undesired nitrogen derivative compounds formation; and
subjecting the isolated liquefied fat to bleaching in the presence of acid and sorbent to obtain bleached liquefied fat.

2. The method according to claim 1, wherein the solid material from which the nitrogen-depleted liquefied fat is isolated, is nitrogen-enriched solid material.

3. The method according to claim 1, wherein the isolating of the nitrogen-depleted liquefied fat from the solid material is carried out simultaneously during the heating of the animal waste feedstock to the elevated temperature of 100° C. or below.

4. The method according to claim 1, wherein, before the bleaching, the isolated liquefied fat is subjected further to heat-treatment to precipitate phosphorous and/or metal containing impurities.

5. The method as claimed in claim 4, wherein the heat-treatment of the isolated liquefied fat is carried out at a temperature from 180 to 300° C., preferably from 240° C. to 280° C.

6. The method as claimed in claim 4, wherein the heat-treatment of the isolated liquefied fat is carried out at a pressure from 50 kPa to 500 kPa, preferably from 70 to 400 kPa, more preferably from 100 to 300 kPa, yet more preferably from 105 to 270 kPa.

7. The method according to claim 1, wherein the isolated liquefied fat is subjected to sterilisation before the bleaching, preferably the sterilization is carried out directly after the liquefying of the fat solids and isolating of the nitrogen-depleted liquefied fat.

8. The method as claimed in claim 1, wherein before the bleaching step, the isolated liquefied fat is subjected to centrifugation to remove stick water.

9. The method according to claim 1, wherein the isolated liquefied fat is blended with plant-based fat waste, and/or any types of animal fats or rendered animal fats, before heat-treatment, before sterilisation, and/or before bleaching or any combinations thereof.

10. The method according to claim 1, wherein the heating of said animal waste feedstock to an elevated temperature of 100° C. or below, is carried out in a container by means of a heat exchanger.

11. The method according to claim 10, wherein the isolating of the liquefied fat from the solid material is carried out by means of a separator in the container.

12. The method according to claim 11, wherein the separator is a guard bed having perforations, upon which the animal waste feedstock is placed to allow the liquefied fat to drain through the perforations.

13. The method according to claim 10, wherein the container is configured to separate the liquefied fat from the solid material as soon as it forms or during liquefying, preferably the container is a screw press.

14. The method according to claim 1, wherein the duration of the heating of the animal waste feedstock to the elevated temperature of 100° C. or below to liquefy the fat solids in the animal waste feedstock is about 30-90 minutes.

15. The method according to claim 1, wherein the sorbent of the bleaching step is a bleaching clay, and the acid of the bleaching step is selected from citric acid and phosphoric acid, or combination thereof.

16. The method according to claim 1, wherein the bleached liquefied fat is subjected to a catalytic hydrotreatment step in the presence of hydrogen to produce biofuel.

17. The method according to claim 1, wherein the undesired nitrogen derivative compounds are amines and/or amides.
